(19) United States
(12) Patent Application Publication
(10) Pub. No.: US 2002/0195530 A1
(43) Pub. Date: Dec. 26, 2002

(54) Rack method and apparatus for point of purchase advertising

(76) Inventor: Denise Mraz, Brecksville, OH (US)

Correspondence Address: Heather M. Barnes, Fourteenth Floor, One Cascade Plaza, Akron, OH, 44308, US

(21) Appl. No.: 09/892,005

(22) Filed: Jun. 26, 2001

(51) Int. Cl. A47K 1/00; E04G 3/00; E04G 5/06; F21V 21/00; A47G 29/00; F21V 35/00; A47B 96/06

(52) U.S. Cl. 248/220.43

(57) ABSTRACT

A rack apparatus and method for point-of-purchase advertising comprises a racking unit, a pivotable door swing having a first portion and a second portion, an advertisement attaching to the door swing, and a bracket assembly attaching to the racking. The bracket assembly has a faceplate adapted to be selectively attachable to the racking unit. The faceplate comprises a substantially planar body with first and second surfaces, a plurality of slots distributed about the planar body, means for receiving the pivotable door swing, and means for attached the faceplate to the racking unit such that the second surface of the planar body contacts the racking unit. The means for receiving the pivotable door swing may comprise a gravity close feature, such that the first portion of the pivotable door swing comes to rest against, or in close proximity to, the racking unit. The present invention provides a rack apparatus that is universal to all racking units in point-of-purchase locations.

### BACKGROUND OF THE INVENTION

1. Field of Invention

This invention pertains to the art of methods and apparatuses for a rack method and apparatus for point of purchase advertising. More specifically, the present invention relates methods and apparatuses for a bracket assembly and door swing, which display advertisements at point of purchase locations.

2. Description of the Related Art

Most retailers of the warehouse type display their goods on tall shelving units, which quite often can extend upwardly almost to the ceiling of the building. The lower shelves, that is, those within reach of the customers, are stocked with merchandise being currently offered for sale. The upper shelves are often utilized to store inventory of various goods.

It is a common practice to hang a display sign from one of these upper shelves to provide sale information and product identification for the products carried by the lower shelves. Although such a system permits the retailers to use all available space to display products and store inventory, while at the same time providing a sign to convey information regarding the products being displayed, the signs obstruct the retailer from access from the inventory behind them. Thus, when inventory is to be removed from or added to these upper shelves, the signs must be temporarily removed and then replaced, which is a time consuming project for the retailer.

Another common disadvantage that retailers face is the empty spaces on shelves that results as inventory depletes. Retailers do not want customers to see empty shelves because consumers may draw false conclusions that the retailer does not have much selection, that the retailer simply does not carry a specific product, or even financial instability. As inventory is sold, retailers find it desirable to cover these empty spaces with advertisements so that customers do not see empty spaces and so that the point-of-purchase location is aesthetically more pleasing. Again, these advertisements must be capable of being easily removed so that inventory can be easily stocked or removed from the shelves.

Many of the warehouse type retailers have different types of racking shelf units. These may include a cantilever-tapered arm, an H-rack, or an I-beam. Currently, no racking apparatus is available, which can be universally adapted to different types of racking units.

Thus, there is a need in the art for a rack method and apparatus for point-of-purchase advertising that can be universally applied to all racking shelf units at point-of-purchase locations, whereby, an advertising sign or banner can be readily positioned so that inventory can be easily stored behind it.

### SUMMARY OF THE INVENTION

A point-of-purchase advertising system comprises of a racking unit, a pivotable door swing having a first portion and a second portion, an advertisement attaching to the door swing, and a bracket assembly attaching to the racking. The pivotable door swing is adapted to pivot about a vertical axis. The bracket assembly has a faceplate adapted to be selectively attachable to the racking unit. The faceplate comprises a substantially planar body with first and second surfaces, a plurality of slots distributed about the planar body, means for receiving the pivotable door swing, and means for operatively connecting the faceplate to the racking unit, such that, the second surface of the planar body contacts the racking unit. Accordingly, it is an object of the present invention to provide a rack apparatus that is universal to all racking unit 74s in point-of-purchase locations.

It is yet another object of the present invention to provide a rack apparatus wherein the means for receiving the pivotable door swing comprises an upper tab and a lower tab, each having an aperture defined therein, wherein the upper tab and lower tab extend from the planar body of the faceplate and are substantially perpendicular to the planar body so that the apertures of the upper and lower tabs are substantially aligned to receive the second portion of the door swing.

It is yet another object of the present invention to provide a rack apparatus where the means for receiving the pivotable door swing is a tube attached to the first surface of the faceplate.

Further, another object of the present invention is to provide a rack method that further comprises an angle bracket for securing the faceplate to the racking unit, where the angle bracket comprises a main portion with a hole defined therein, where the hole is adapted to receive a fastener, and a lip extended substantially perpendicular from the main portion. The lip has at least two slots, which are adapted to be in selective and operative alignment with two of the plurality of the slots of the faceplate.

Still, another object of the present invention is to provide a rack apparatus that is attachable to a racking unit that is a cantilever-tapered arm.

Still, yet another object of the present invention is to provide a rack apparatus that is attachable to a racking unit that is an H-rack.

Still yet, another object of the present invention is to provide a rack apparatus that attaches to a racking unit that is a cantilever I-beam.

Another object of the present invention is to provide a rack apparatus where the plurality of slots distributed about the body of the faceplate is substantially oval.

Further, another object of the present invention is to provide a rack apparatus where the body of the faceplate has edges, and the slots are angularly positioned relative to the body edges.

Still yet, another object of the present invention is to provide a rack apparatus further comprising a multiple door swing bracket adapted to attach to the faceplate, such that, at least two door swings may be simultaneously received by the bracket assembly.

Further, another object of the present invention is to provide a rack method with a multiple door swing bracket where the multiple door swing comprises a main body portion and first and second flanges extending substantially perpendicular from the main body portion. The first and second flanges comprise of plurality of holes, where each of said plurality of holes in the first flange is coaxial with each of the plurality of holes in the second flange. At least one of the holes of the first and second flanges is adapted to receive a fastener.

Another object of the present invention is to provide a rack apparatus where the holes of the first and second flanges for receiving the fastener of the multiple door swing bracket are in operative alignment with the means for receiving the pivotable door swing of the faceplate.

Still yet, another object of the present invention is to provide a rack apparatus where the faceplate comprises a top edge and the door swing is adapted to be positioned below the top edge when the door swing is received by the means for receiving the door swing.

It is yet another object of the present invention to provide a rack apparatus where the second portion of the door swing comprises a hole defined therein for receiving a securing mechanism, where the securing mechanism may be a cotter pin, a key ring, or a commercial plastic tie.

Further, another object of the present invention is to provide a racking method for operating a banner door system comprising the steps of providing the rack apparatus, attaching the bracket assembly to the racking unit, attaching the banner onto the first portion of the door swing, seating the second portion of the door swing into the means for receiving the door swing of the faceplate, and positioning the door swing such that the banner can be viewed.

Still yet, another object of the present invention is to provide a method for operating a banner door system, which comprises the steps of providing securing means for preventing the door swing from unseating from the means for receiving the door swing, and attaching the securing means through the hole of the second end of the door swing.

Another object of the present invention is to provide a rack apparatus having an informational display that provides a large area for graphics, which is helpful to the consumer to understand product information and/or product assembly.

Still other benefits and advantages of the invention will become apparent to those skilled in the art to which it pertains upon a reading and understanding of the following detailed specification.

### BRIEF DESCRIPTION OF THE DRAWINGS

The invention may take physical form in certain parts and arrangement of parts, a preferred embodiment of which will be described in detail in this specification and illustrated in the accompanying drawings which form a part hereof and herein:

FIG. 1 is a perspective view of the present view;

FIG. 2 is a side view of FIG. 1;

FIG. 3 is a front view of FIG. 1;

FIG. 4 is a top view of FIG. 1;

FIG. 5 is a perspective view of the faceplate of the present invention;

FIG. 6 is a front view of FIG. 5;

FIG. 7 is a top view of FIG. 5;

FIG. 8 is a bottom view of FIG. 5;

FIG. 9 is a side view of FIG. 5;

FIG. 10 is a perspective view of the angle bracket of the present invention;

FIG. 11 is a side view of FIG. 10;

FIG. 12 is a top view of FIG. 10;

FIG. 13 is a side view of FIG. 11 taken along line 1313;

FIG. 14 is a perspective view of the multiple door swing bracket of the present invention;

FIG. 15 is a side view of FIG. 14;

FIG. 16 is a top view of FIG. 14;

FIG. 17 is a front view of FIG. 14;

FIG. 18 is a top plan view of the multiple door swing bracket before it is stamped to the configuration shown FIG. 14;

FIG. 19 is a side view of the multiple door swing bracket attaching to the faceplate 12;

FIG. 20 is an exploded view of the present invention attaching to a cantilever-tapered arm;

FIG. 21 is an exploded view of the present invention attaching to an H-rack; and,

FIG. 22 is an exploded view of the present invention attaching to a cantilever I-beam.

### DESCRIPTION OF THE PREFERRED EMBODIMENT

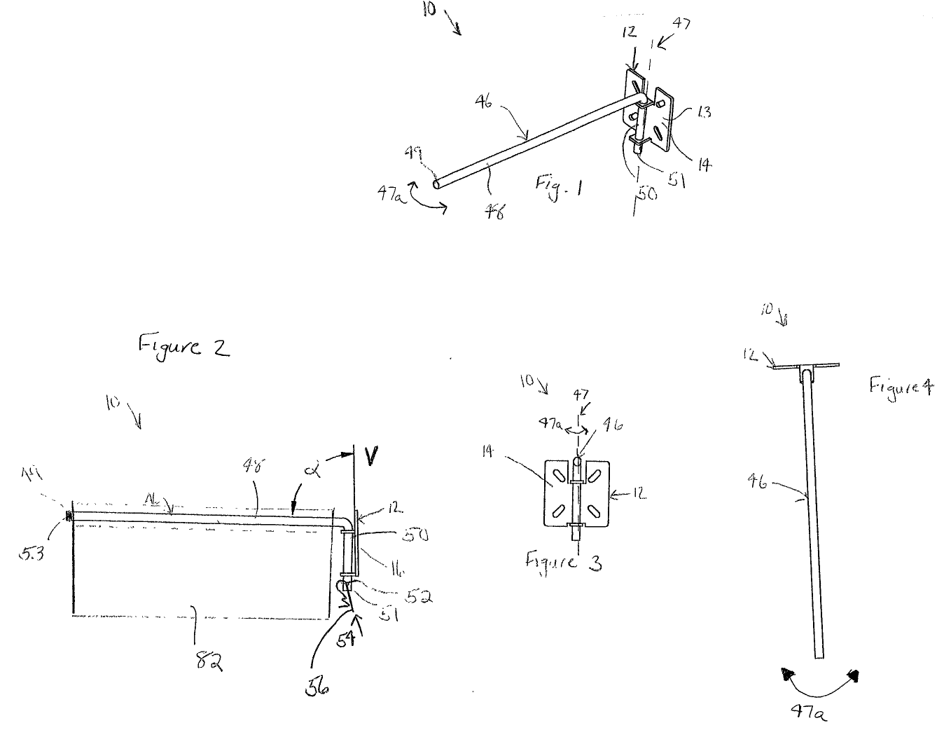

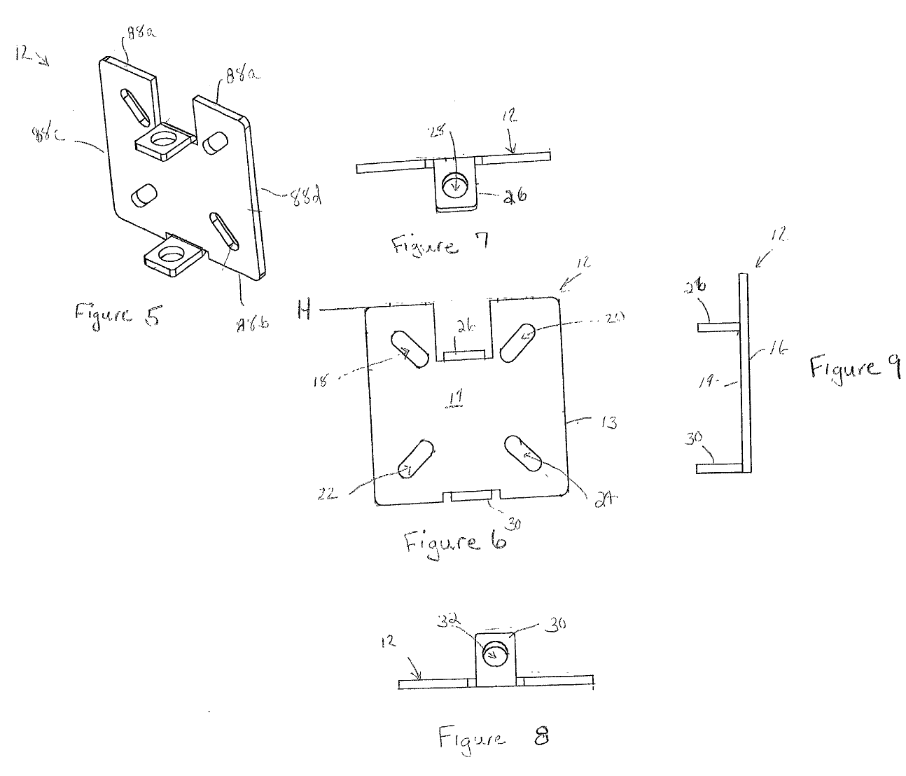

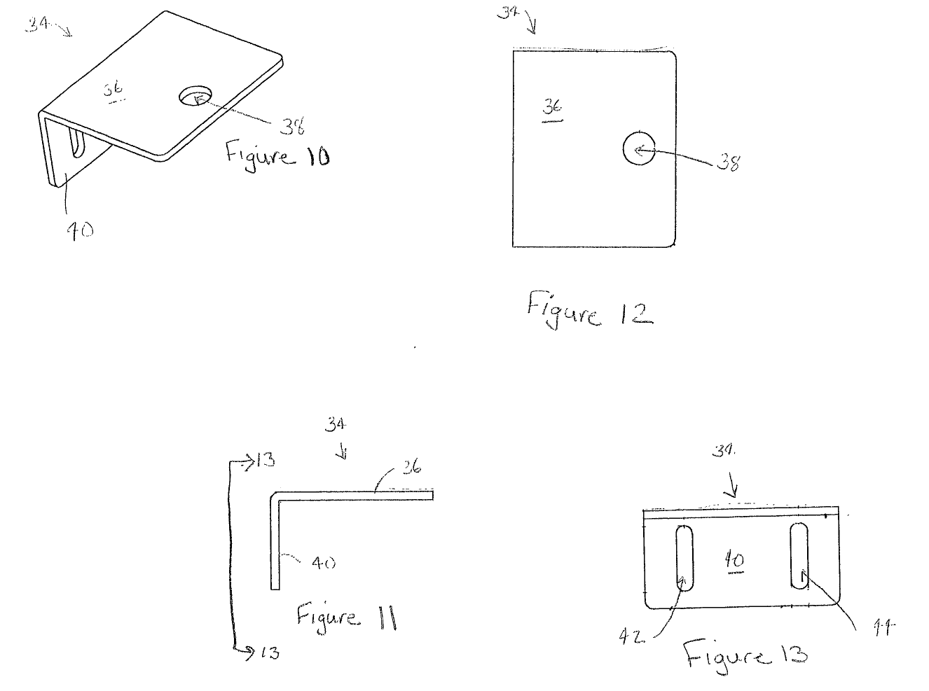

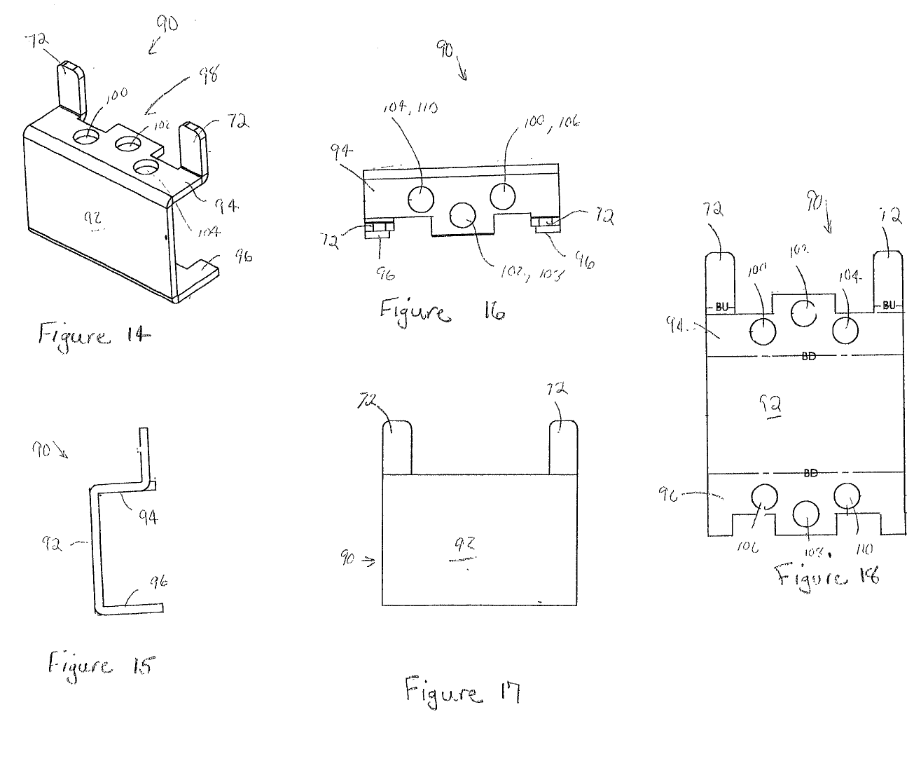

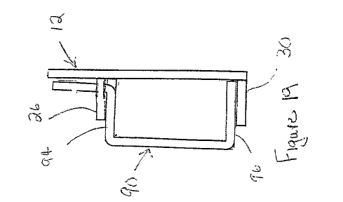

Referring now to the drawings wherein the showings are for purposes of illustrating a preferred embodiment of the invention only and not for purposes of limiting the same, FIGS. 1 through 22 show the present invention. The present invention is a rack method and apparatus for displaying advertisements or other informational displays at point-of-purchase locations. What is meant by the term “point-of-purchase” is any retail location where a consumer may purchase a product. Point-of-purchase locations may include a retail outlet, a mail order house, or other place where an item can be purchased. What is meant by the term “rack” or “rack shelving unit” or “racking unit” is any shelving unit used in a retailer establishment, which may include without limitation, a cantilever-tapered arm shelving unit, an H-rack shelving unit, a cantilever I-beam shelving unit, and/or a wood shelving unit. It is also contemplated to be within the scope of the invention to apply the rack apparatus to shelving units made of other material, including without limitation, wood. More specifically, some retailers utilize wood pallets rather than racking units. In these applications, the present can be utilized with the wood pallets. These racking units are well known in the art and will not be further described herein.

Turning now to FIGS. 1-4, a rack apparatus 10 comprises a racking unit 74 and a pivotable door swing 46 having a first portion 48 and a second portion 50. An informational display 82, such as a banner advertisement or sign, operatively connects to the door swing 46. The point-of-purchase advertising system 10 also comprises a bracket assembly 11, which is operatively connected to the racking unit 74. The bracket assembly 11 comprises a faceplate 12, which is adapted to be selectively attachable to the racking unit 74.

The faceplate 12 comprises a substantially planar body 13 with a first surface 14 and a second surface 16. The faceplate 12 also comprises first, second, third, and fourth elongated slots 18, 20, 22, 24 distributed about the planar body 13. The faceplate 12 has means for receiving the pivotable door swing 25. Also, the faceplate 12 comprises means for attaching the faceplate 12 to the racking unit 74 such that the second surface 16 of the planar body 13 contacts at least some portion of the racking unit 74.

Usually, the means for attaching the faceplate 12 to the racking unit 74 is a fastener 59, such as bolts and nuts. However, plastic industrial ties 58 may be used to secure the bracket assembly 11 to the racking unit 74, namely the faceplate 12. When the plastic industrial ties 58 are utilized, it is preferred that four ties are used to attach the faceplate 12 to the racking unit 74. One tie is wrapped through the first and second slots 18, 20; one tie attaches through the third and fourth slots, 22, 24; another tie is wrapped diagonally across the faceplate 12 through the first and fourth slots 18, 24; and the fourth tie is wrapped through the second and third slots 20, 22. The means for attaching the faceplate 12 may also take the form of a strong magnet (not shown) attached to the second surface 16 or the faceplate 12. When the rack apparatus 10 is used with a wood shelving unit, the bracket assembly 11 may attach thereto by way of screws and washers (not shown).

The means for receiving the pivotable door swing 25 may be any mechanism, which operatively connects the pivotable door swing 25 to the faceplate 12 such that the pivotable door swing can pivot about a vertical axis. Although not required, it is preferred that the means for receiving the pivotable door swing 25 comprise a “gravity close” feature. What is meant by the term “gravity close” is the capability of the pivotable door swing 25 to obtain its natural or resting position, with or without the informational display 82 attached thereto, through gravity such that it naturally comes to rest against, or in proximity to, the racking unit 74. It should be understood that the door swing 25 does not need to physically contact the racking unit 74. The door swing need only to pivot towards the racking unit 74, such that the first portion 48 is in proximity to the racking unit 74 as previously described.

The means for receiving the pivotable door swing 25 may comprise a tube 86, which is attached to the first surface 14 of the faceplate 12, as best seen in FIGS. 2022. The tube may attach to the face plate 12 through any known method known in the art, such as, but not limited to welding. In this embodiment, the second portion 50 of the door swing 46 is received into the tube 86 by sliding the same therein. The second portion 50 is nearly completely enclosed by the tube 86. In order to achieve the gravity close feature with the tube 86, the tube 86 should be welded such that the bottom of the tube 86 is closer to the faceplate 12 than the top of the tube. Alternatively, an additional working piece (not shown) may be operatively connected to the faceplate 12 in an angled position such that the gravity close feature can be achieved. The tube 86 may be welded, or attached by another method, to the working piece so that the tube is in the position previously described.

As specifically shown in FIGS. 5-8, another embodiment of the means for receiving the pivotable door swing 25 comprises an upper tab 26 having an aperture 28 defined therein. The upper tab 26 extends from the planar body 13 and is substantially perpendicular to the planar body 13. The faceplate 12 shown in FIGS. 5-8 also comprises a lower tab 30 having an aperture 28 defined therein. The lower tab 30 also extends from the planar body 13 of the faceplate 12 and is substantially perpendicular thereto. The apertures 28, 32 of the upper and lower tabs 26, 30 are substantially aligned to receive the second portion 50 of the door swing 46. Again, the second portion 50 simply slides into the first aperture 28 and then through the second aperture 32 in order to be properly seated. Viewing FIGS. 5, 7, and 8, the apertures 28, 32 defined in the upper and lower tabs 26, 30 are angled to provide the gravity close feature previously described herein. Since the apertures 28, 32 are angled, the natural position of the pivotable door swing 25 and the informational display 82 is substantially parallel to the racking unit 74.

As shown in FIGS. 1-4 and 20-22, the door swing 46 is adapted to pivot about a vertical axis 47, as shown by directional arrow 47a. Further, the pivotable door swing 46 may be a shaft or rod. The first portion 48 of the door swing 46 is substantially longer than the second portion 50. The first portion 48 and the second portion 50 form a substantially 90° angle. The first portion 48 of the door swing 46 is adapted to receive the informational display 82, which carries the advertisement and/or product information. Preferably, the informational display 82 comprises a pocket, which can be slid over the first portion 48 of the door swing 46. As previously stated, the second portion 50 of the door swing 46 is simultaneously received by the means for receiving the door swing 25, namely, the upper and lower tabs 26, 30 of the faceplate 12 as shown in FIGS. 1-4 or the tube 86, as shown in FIGS. 20-22.

The door swing 46 also comprises a first end 49 and a second end 51. The first end 49 may have a plastic cap 53 placed thereon so that the informational display 82 is not damaged by rough edges of the door swing 46. The second end 51 of the door swing 46 has a securing hole 52 defined therein for receiving a securing mechanism 54, such that the door swing 46 does not unseat when in use. The securing mechanism 54 may be of any form, including without limitation, a commercial plastic tie 58, a split ring cotter pin 56, a key ring, or other similar device, which prevents the door swing 46 from unseating. When the door swing 46 takes the form of a rod 50 as shown in FIGS. 1-4 and 20-22, the diameter of the rod 50 may range anywhere from 1/4 inch to one-inch. In the preferred embodiment, the diameter of the rod 50 may be approximately 3/8 inch for smaller informational displays 82 or 1/2 inch for larger informational displays 82. Naturally, as the door swing 46 increases in diameter, it is capable of supporting larger informational displays 82.

Turning now to FIG. 2, the planar body of the faceplate 12 defines a vertical plane V when the door swing 46 is seated within the upper and lower tabs 26, 30 of the faceplate 12. The first portion 48 of the door swing 46 forms an angle α less than or equal to 90° with the vertical plane V of the faceplate 12, which is a result of the angled apertures 28, 32 previously described and shown in FIGS. 5, 7, and 8. Returning to FIG. 2, it is preferred that the angle α is approximately 88°. With this angle between the first portion 48 of the door swing 46 and the vertical plane of the faceplate 12, the gravity close feature provides for the door swing 46 to be more stationary when it is positioned against the racking units 74. That is, it is not as susceptible to freely pivot within the means for receiving the door swing 25.

Returning to FIGS. 5-8, the faceplate 12 has edges 88, including a top edge 88a, a bottom edge 88b, and two side edges 88c, 88d. The top edge 88a defines a horizontal plane H. When the door swing 46 is seated within the means for receiving the pivotable door swing 25, the first portion 48 of the door swing remains below the horizontal plane H. With this configuration, it is possible for forklifts, or other means of moving inventory, to access the shelf above the informational display without having to remove or reposition the informational display 82. The informational display 82 does not interfere with the removal or addition of inventory from higher shelves. Since the informational display 82 can remain in place, it is that much easier to use the present invention within warehouse type establishments.

FIGS. 5 and 6 show that the first, second, third and fourth elongated slots 16, 18, 20 and 22 are distributed about the planar body 13 of the faceplate 12. Although the slots may take any shape, it is preferred that these shapes are oval. Further, it is also preferred that the elongated slots 16, 18, 20 and 22 are substantially positioned 45° relative to the side edges 18c, 18d of the planar body 13 of the faceplate 12. It is this bolt pattern formed by these elongated slots 16, 18, 20 and 22 that allows the bracket assembly 11 to be universal so that it adapts to fit any racking unit 74, such as, a cantilever I-beam 80, a cantilever-tapered arm 76, or an H-rack 78.

Turning now to FIGS. 10-13, the rack apparatus 10 further comprises an angle bracket 34 for securing the faceplate 12 to the racking unit 74. The angle bracket 34 comprises a main portion 36 with a hole 38 defined therein. The hole 38 is adjacent to an edge of the main portion 36, and it is adapted to receive the means for attaching the faceplate 12 to the racking unit 74. It is preferred that either bolts or plastic industrial ties 58 be used to secure the angle bracket to the faceplate 12 and/or to the racking unit 74. The angle bracket 34 also comprises a lip 40 extending substantially perpendicular from the main portion 36. The lip 40 comprises at least a first slot 42 and a second slot 44. The slots 42, 44 are adapted to be in selective and operative alignment with two of the elongated slots 16, 18, 20, 22 of the faceplate 12.

Viewing FIGS. 14-18, a multiple door swing bracket 90 will now be described. The multiple door swing bracket 90 is adapted to operatively connect to the faceplate 12, such that at least two door swings 46 may be simultaneously received by the bracket assembly 11. The multiple door swing bracket 90 comprises a main body portion 92, a first flange 94, and a second flange 96. The first and second flanges 94, 96 extend substantially perpendicular from the main body portion 92. The first and second flanges 94, 96 each comprise a plurality of holes 98. Each of the plurality of holes in the first flange 94 is coaxial and corresponds with each of the plurality of holes in the second flange 96. At least one of the holes of the first and second flanges 94, 96 is adapted to receive a fastener, such as a carriage bolt. As shown in FIGS. 14-18, three holes 100, 102, 104 are defined in the first flange 94 and three holes 106, 108, 110 are defined in the second flange 96. These embodiments show that the carriage bolt should be inserted through the central holes 102 and 108. In this way the door swings 46 may be inserted through the outer holes 100, 104, 106, 110.

The multiple door swing bracket 90 also comprises at least two stops 72. The stops 72 extend substantially perpendicular to the first flange 94. In order to prevent damage to the informational display 82, the tabs 72 have chamfered edges. These chamfered edges may be placed at any selected position of the bracket assembly to prevent damage to the informational display 82. The stops 92 prevent the door swing 46 that is inserted in the outer holes 100, 104, 106, 110 from rotating past the shelving unit. More specifically, the informational display 82 remains flush with respect to the shelving units so that the informational displays 82 can be properly viewed.

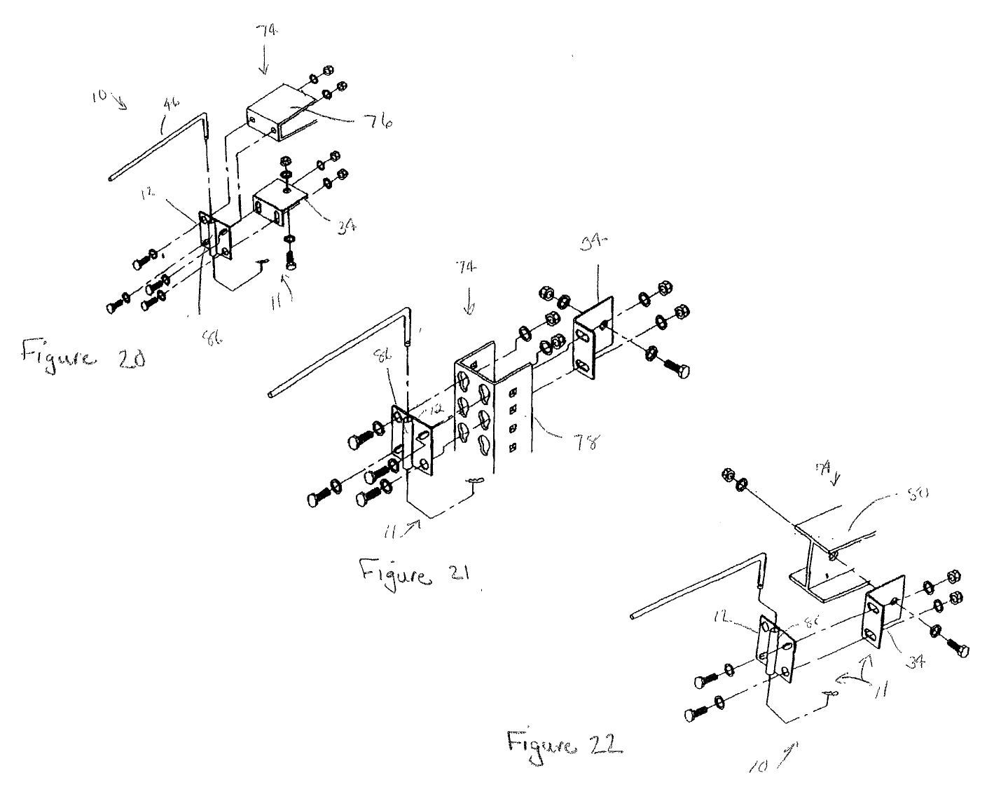

Turning to FIG. 19, the present invention is shown where the multiple door swing bracket 90 is attached to the faceplate 12. As shown in FIG. 19, the center holes 102, 108 of the first and second flanges 94, 96 of the multiple door swing bracket 90 are positioned over the upper and lower tabs 26, 30, respectively, of the faceplate 12. A fastener is simultaneously received by the apertures 28, 32 of the upper and lower tabs 26, 30 of the faceplate 12 and the center holes 102, 108 of the first and second flanges 94, 96 of the multiple door swing bracket 90. As previously stated, this bracket assembly 11, when attached to the racking unit 74, can accept two door swings 46, such that informational displays 82 can be placed in front of adjacent racking units 74.

All of the components of the bracket assembly 11 are preferably made of steel. More specifically, the faceplate 12, the angle bracket 34, and the multiple door swing bracket 90 are powder coated for indoor-outdoor use. Further, these pieces are formed through a stamping process, which is well known in the art. These same properties are also true for the door swing 46.

A method for operating a banner door system 10 comprises the steps of providing the racking unit 74 that has been previously described, such as a cantilever-tapered arm 76, an H-rack 78, and/or a cantilever I-beam 80. Next, an informational display 82 is provided, as well as, a door swing 46 having a first portion and a second portion 48, 50. Also, the bracket assembly 11 previously described is provided. The bracket assembly 11 is attached to the racking unit 74 and will be further described below. The informational display 82 is attached to the first portion 48 of the door swing 46. As previously described, if there is a pocket in the informational display 82, the pocket can receive the first portion 48 of the door swing 46. Next, the second portion 50 of the door swing 46 is seated into the means for receiving the pivotable door swing 25 of the faceplate 12. If there is a grommet provided in the informational display 82, this can be secured to the second portion 50 of the door swing 46 by use of the plastic commercial tie 58 or other similar fastener. The door swing 46 can then be positioned such that the informational display 82 can be viewed. Once the door swing 46 is seated in the means for receiving the pivotable door swing 25, the securing mechanism 54 may be provided for preventing the door swing 46 from unseating when it is displaying the informational display 82. The securing mechanism 54 can be attached through the hole 38 at the second end 51 of the door swing 46.

Turning now to FIGS. 20 through 22, exploded views are shown of the present invention using the faceplate 12, the door swing 46, and the angled bracket 34. Although the angled bracket 34 is depicted in FIGS. 20 through 22, it is only required in the application of the racking unit 74 that is a cantilever I-beam 80. The angle bracket 34 provides additional support to the rack apparatus 10 when used with the H-rack 78 and the cantilever-tapered arm 76.

Turning now to FIG. 20, it is shown that in the application of a cantilever-tapered arm 76, the first and second slots 18, 20 of the faceplate 12 are attached to corresponding slots of the cantilever-tapered arm 76. The third and fourth elongated slots 22, 24 of the faceplate 12 are attached to the first and second slots 42, 44 of the angled bracket 34. A fastener may also be inserted through the hole 38 defined in the main portion 36 of the angled bracket 34 to provide extra support. Note that it is not necessary for the fastener to actually attach through the cantilever-tapered arm 76 through the angle bracket 34.

FIG. 21 shows the application of the present invention when the racking unit 74 is an H-rack 78. In this embodiment, the four elongated slots 16, 18, 20 and 22 of the faceplate 12 are attached to the racking unit 74 through the fasteners. The second and fourth slots 20, 24 are in operative alignment with the first and second slots 42, 44 of the angled bracket 34 and are attached to each other through the various fasteners previously described. Once this is assembled to the H-rack 78, the door swing 46 may be positioned into the means for receiving the pivotable door swing 25.

Viewing FIG. 22, the application for using the present invention is with a racking unit 74 that is a cantilever I-beam 80. The hole 38 of the main body portion 36 of the angled bracket 34 is secured through a hole 112 in the cantilever I-beam 80 through a fastener. The second and fourth slots 42, 44 of the angled bracket 34 then align with the second and fourth slots 20, 24 of the faceplate 12. The door swing 46 can then be inserted through the means for receiving the pivotable door swing 25. It would be the retailer's preference as to whether or not to attach the second and fourth slots 20, 24 to the angled bracket 34 or to attach the first and third slots 18, 22 to the angled bracket 34. It is preferred that the second and fourth slots 20, 24 are attached to the angled bracket 34 so the second surface 16 of the faceplate 12 can have greater surface contact with the cantilever I-beam 80 and, thus, provide more support.

No matter what type of shelving unit is utilized with the present invention, inventory is easily moved without having to remove the informational display 82. Inventory located above the informational display 82 can be easily reached since the door swing 46 sits below the horizontal plane of the faceplate 12. In the event inventory is needed from behind an informational display 82, the door swing 46 can be easily pivoted within the means for receiving the door swing 25. Another advantage of the present invention is that the door swing 46 holding the informational display can be removed from the bracket assembly 11 with the informational display 82 still attached and relocated to another bracket assembly of a different racking unit in the point-of-purchase establishment.

The invention has been described with reference to a preferred embodiment. Obviously, modifications and alterations will occur to others upon a reading and understanding of this specification. It is intended to include all such modifications and alternations in so far as they come within the scope of the appended claims or the equivalence thereof.

Having thus described the invention, it is now claimed:

What is claimed is:

1. A rack apparatus for use with a racking unit at a point-of-purchase location, said rack apparatus, comprising:
a pivotable door swing having a first portion and a second portion, said pivotable door swing adapted to pivot about a vertical axis;
a bracket assembly operatively connecting to said racking unit, said bracket assembly having a faceplate adapted to be selectively attachable to said racking unit, said faceplate comprising:
a substantially planar body with first and second surfaces;
a plurality of slots distributed about said body;
means for receiving said second portion of said pivotable door swing; and,
means for operatively connecting said faceplate to said racking unit such that at least a portion of said second surface of said planar body contacts said racking unit.

2. The rack apparatus of claim 1, wherein said means for receiving said pivotable door swing is adapted to provide a gravity close, such that the first portion of the pivotable door swing is in close proximity to the racking unit.

3. The rack apparatus of claim 1, wherein said means for receiving said pivotable door swing is a tube attached to said first surface of said faceplate.

4. The rack apparatus of claim 1, further comprising an angle bracket for securing said faceplate to said racking unit, said angle bracket, comprising:
a main portion with a hole defined therein, said hole adapted to receive a fastener; and,
a lip extending substantially perpendicular from said main portion, said lip comprising at least two slots, said slots adapted to be in selective and operative alignment with two of said plurality of said slots of said faceplate.

5. The rack apparatus of claim 4, wherein said racking unit is a cantilever-tapered arm.

6. The rack apparatus of claim 4, wherein said racking unit is an H-rack.

7. The rack apparatus of claim 4, wherein said racking unit is a cantilever I-beam.

8. The rack apparatus of claim 1, wherein said plurality of slots distributed about said body of said faceplate is substantially oval.

9. The rack apparatus of claim 1, wherein said faceplate has four slots distributed about said body.

10. The rack apparatus of claim 9, wherein said body has edges, said slots being angularly positioned relative to said body edges.

11. The rack apparatus of claim 1, further comprising a multiple door swing bracket adapted to operatively connect to said faceplate such that at least two door swings may be simultaneously received by said bracket assembly.

12. A rack apparatus for hanging an informational display at a point-of-purchase location, said banner door system, comprising:
a racking unit;
a door swing having a first portion and a second portion, said informational display attached to said first portion of said door swing, said door swing adapted to pivot about a vertical axis; and,
a universal bracket assembly adapted to attach to different racking units, said bracket assembly having a faceplate, said faceplate comprising:
a body with first and second surfaces, said second surface adapted to contact said racking unit;
a plurality of slots defined in and distributed about said body; and,
means for receiving said second portion of said pivotable door swing.

13. The rack apparatus of claim 12, wherein said bracket assembly further comprises an angle bracket, said angle bracket comprising:
a main portion with a hole defined therein, said hole adapted to receive a fastener; and,
a lip extending substantially perpendicular from said main portion, said lip comprising at least two slots, said slots adapted to be in selective and operative alignment with two of said plurality of said slots of said faceplate.

14. The rack apparatus of claim 12, further comprising a multiple banner door adapted to operatively connect to said faceplate such that at least two door swings may be simultaneously received by said bracket assembly.

15. The rack apparatus of claim 12, wherein said means for receiving said pivotable door swing is a tube attached to said first surface of said faceplate.

16. The rack apparatus of claim 12, wherein said body comprises a top edge, said door swing adapted to be positioned below said top edge when said door swing is received in said apertures of said upper and lower tabs.

17. The rack apparatus of claim 12, wherein said door swing further comprises a first end and a second end, said second end of said door swing having a hole defined therein for receiving a securing mechanism.

18. The rack apparatus of claim 17, wherein said securing mechanism is a split ring cotter pin.

19. The rack apparatus of claim 17, further comprising a cap attached to said first end of said door swing.

20. A method for operating a rack apparatus, the method comprising the steps of:
providing a racking unit;
providing an informational display;
providing a door swing having a first portion and a second portion;
providing a bracket assembly, said bracket assembly comprising a faceplate, said faceplate having a plurality of slots, said faceplate having means for receiving said door swing;
attaching said bracket assembly to said racking unit;
attaching said banner onto said first portion of said door swing;
seating said second portion of said door swing into said means for receiving said door swing of said faceplate; and,
positioning said door swing such that said banner can be viewed.

21. The method of claim 20, wherein said door swing comprises a first end and a second end, said second end of said door swing has a hole defined therein, said method further comprises the steps of:
providing securing means for preventing said door swing from unseating in said means for receiving said door swing;
attaching said securing means through said hole of said second end of said door swing.

22. A rack apparatus for hanging at least one advertisement at a point of purchase location, said rack apparatus, comprising:
a racking unit;
a banner;
a door swing having a first portion and a second portion, said banner attaching to said first portion of said door swing, said first portion and second portion forming an angle that is substantially ninety degrees, said door swing being a rod, said second end of said door swing having a hole defined therein for receiving a securing mechanism, said door swing pivoting about a vertical axis; and,
a bracket assembly, comprising:
a faceplate, said faceplate comprising:
a body with first and second surfaces, said second surface adapted to contact said racking unit;
a plurality of slots defined in and distributed about said body;
means for receiving said second portion of said door swing operatively connected to said first surface of said faceplate, wherein said means for receiving said pivotable door swing is adapted to provide a gravity close, such that the resting position of the first portion of the pivotable door swing is adapted to be in close proximity to the racking unit; and,
a top edge, said door swing adapted to be positioned below said top edge when said door swing is received in said tube; and,
an angle bracket, comprising:
a main portion with a hole defined therein, said hole adapted to receive a fastener; and,
a lip extending substantially perpendicular from said main portion, said lip comprising at least two slots, said slots adapted to be in selective and operative alignment with two of said plurality of said slots of said faceplate.
